(19) United States
(12) Patent Application Publication
(10) Pub. No.: US 2002/0014029 A1
(43) Pub. Date: Feb. 7, 2002

(54) Pre-surgical safety, warning, notification, and/or alerting device

(76) Inventor: James B. Copelan, Santa Clarita, CA (US)

Correspondence Address: Linda Flewellen Gould, Gould & Whitley, 1665 Briargate Blvd, Suite 101, Colorado Springs, CO, 91380-2976, US

(21) Appl. No.: 09/729,888

(22) Filed: Dec. 4, 2000

Related U.S. Application Data
(60) Provisional application No. 60/169,399, filed on Dec. 6, 1999.

(51) Int. Cl. G09F 3/10

(52) U.S. Cl. 40/638; 40/299.01

(57) ABSTRACT

Accidental surgical procedures are sometimes performed on patients' limbs, tissue and/or other body parts. These surgical mistakes are tragic for the patient and cost hundreds of millions of dollars each year in lawsuits and damage awards against doctors, hospitals and/or other health care providers. Media attention has exposed this disturbing trend, but there has been no practical solution to the problem until the advent of the present invention.

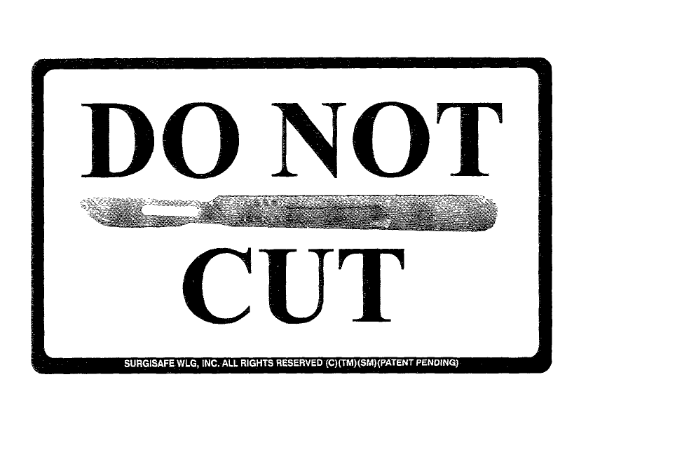

The invention is a pre-surgical safety, warning, notification, and/or alerting device intended to help avoid surgical procedures from being accidentally performed on patients' unintended limbs, tissue and/or other body parts.

The within non-provisional Utility Patent Application is filed herein in reference to:

Provisional Patent Application # 60/169,399, filed Dec. 6, 1999.

This invention pertains to an instantly recognizable method of warning the surgical health care provider(s) that they are not at the intended surgical site.

It is a novel method of providing a pre-surgical safety, warning, notification, and/or alerting device, intended to help avoid surgical procedures from being accidentally performed on patients' unintended limbs, tissue and/or other body parts.

### BACKGROUND OF THE INVENTION

Surgical mistakes are tragic for the patient and cost hundreds of millions of dollars each year in lawsuits and damage awards against doctors, hospitals and/or other health care providers. Media attention has exposed this disturbing trend, but there has been no practical solution until the advent of the present invention.

The invention is an instantly recognizable method of warning the surgical health care provider(s) that they are not at the intended surgical site. It is an opportunity to improve patient care and reduce risk, and should be a basic step in the surgical preparation process. Why should one more patient suffer the dire consequences of having the wrong limb amputated or the wrong organ removed? Why should insurance companies and consumers pay one more huge malpractice award when use of this product could so easily make such losses unnecessary?

The invention will benefit surgical patients, insurers, consumers, and the health care community.

1. Technical Field

This invention pertains to an instantly recognizable method of pre-surgically warning the surgical health care provider(s) that they are not at the intended surgical site.

It is a novel method of providing a pre-surgical safety warning, notification, and/or alert, intended to help avoid surgical procedures from being accidentally performed on patients' unintended limbs, tissue and/or other body parts.

2. Background Art

The American Hospital Association reports that in 1998 there were 25 million hospital surgical procedures for a population of 280 million (9% of population). The procedures and practices that are currently in place to avoid unintended surgeries are insufficient and ineffective.

Patient comfort, protection of body temperature and the identification of the patient, surgeon and surgical site is addressed in U.S. Pat. No. 4,947,867 by Keeton. The Keeton patent (now abandoned) is primarily concerned with the comfort of the patent by providing the patient with a disposable surgical gown of sufficient material to retain body temperature during surgery as well as being able to be cut away at the surgical site.

While the above cited art is useful for its intended purpose of being disposable and keeping the identified patient at a comfortable temperature, it does nothing to pre-surgically warn surgical health care providers that they are not at the intended surgical site.

The within invention is distinguishable from prior art in that the primary purpose and embodiment of the invention is as a pre-surgical safety, warning, notification, and/or alerting device, intended to alert surgical health care providers that they are NOT at the intended surgical site.

### DISCLOSURE OF THE INVENTION

### SUMMARY OF THE INVENTION

An object of this invention is to provide a novel pre-surgical method of providing safety, warning, notification and/or alerting device, intended to help avoid accidental surgical procedures from being performed on patients' unintended limbs, tissue and/or other body parts.

### BRIEF DESCRIPTION OF THE DRAWING (PHOTOGRAPH)

A frontal view of the invention is attached.

### DETAILED DESCRIPTION OF THE PREFERRED EMBODIMENT

The present invention concerns a new and novel method of providing a pre-surgical safety, warning, notification, and/or alerting device to help avoid surgical procedures from being accidentally performed on patients' unintended limbs, tissue and/or other body parts.

In the following description, numerous specific details are set forth in order to provide thorough understanding of the present invention. It will be obvious, however, to one skilled in the art that the present invention may be practiced without these specific details. Some well-known methods and structures have not been set forth in order not to unnecessarily obscure the description of the present invention.

The preferred embodiment of the invention includes a vinyl, PVC, cellulose, woven filament, fabric or other material strip of various sizes (e.g. 2 inches by 3 inches) and/or shapes (rectangle, square, round or other) in various color combinations (red, white, etc.). The material may be perforated to allow oxygen to diffuse to the underlying skin and is similar in construction to bandage wound care products without the wound pad. The invention is intended to remain in place for between 24 to 48 hours.

Words, pictorial images, and/or other warning message(s) are printed on the superior (upper/outer) side of the strip. The inferior (bottom/under) side of the strip is coated with adhesive (similar to that customarily used on bandage wound care products) to affix the invention to the skin. Non-stick peelable backing is affixed to the inferior side of the invention and is intended to be removed prior to use. The invention is/may be packaged in a sterile sleeve envelope or on a continuous roll.

The invention may be affixed to the patient pre-surgically by the patient, physician, and/or other health care provider. The invention includes a miniature version of the invention, intended to be affixed to the patient's medical chart to document that the invention has been utilized and has been affixed to pertinent or appropriate area(s) of the patient in order to warn the surgical health care provider(s) that they are not at the intended surgical site.

The foregoing constitute the best mode known by the applicant for carrying out this invention; however, the specific embodiments disclosed are illustrative of the principle of the invention and are not limiting in scope. To the contrary, it is recognized that one of ordinary skill in the art, given this teaching, may make variations in the structure or compositions without departing from the spirit and scope of this invention. Its scope is defined by the following claims including the protection offered by the doctrine of equivalents.

I claim:

1. A pre-surgical safety, warning, notification, and/or alerting device or system comprising, in combination, an effectively shaped topical pre-printed or diagrammed warning strip.

2. A pre-surgical safety, warning, notification, and/or alerting device or system as described in claim 1, including, in combination, an adhesive strip.

3. A pre-surgical safety warning, notification, and/or alerting device or system as described in claim 1, wherein the notification agent is placed onto an adhesive surface.

4. A method for pre-surgically warning, notifying and/or alerting the surgical health care provider(s) that they are not at the intended surgical site, comprising the steps of:
forming a pre-surgical safety warning, notification, and/or alerting device or system in combination with an adhesive strip or surface and applying the safety, warning, notification, and/or alerting device or system topically at a location that alerts the surgical health care provider(s) that they are not at the intended surgical site.

5. A method as defined in claim 4 wherein:
the pre-surgical safety, warning, notification, and/or alerting device or system is attached to an adhesive surface, and topically applying the adhesive surface at a location that alerts the surgical health care provider(s) that they are not at the intended surgical site.

6. A method as defined in claim 5 further comprising:
leaving the pre-surgical safety, warning, notification, and/or alerting device or system on the skin for a predetermined sufficient amount of time for complete, unambiguous pre-surgical identification of the impending surgical site as not being the intended surgical site.

7. A method as defined in claim 6 further comprising an adhesive surface with an effective amount of a vinyl, PVC, cellulose, woven filament, fabric or other material of various sizes and shapes as a pre-printed surface.

8. A pre-surgical safety, warning, notification, and/or alerting device or system for topical application to the skin, comprising:
a pre-surgical safety, warning, notification, and/or alerting device or system, pre-printed and diagrammed; and an adhesive surface onto which the pre-surgical safety warning, notification, alerting device or system can be affixed for topical application to the skin and holding the pre-surgical safety, warning, notification, and/or alerting device or system in contact with a patient's skin at an unintended surgical site.
